(19) United States
(12) Patent Application Publication
(10) Pub. No.: US 2017/0022759 A1
(43) Pub. Date: Jan. 26, 2017

(54) SELF-RESCUE SYSTEM FOR LARGE MACHINES

(71) Applicant: KOMATSU MINING GERMANY GMBH, 40599 Düsseldorf (DE)

(72) Inventors: JENS JUNGHANS, Ratingen (DE); RÜDIGER JUST, Hilden (DE)

(73) Assignee: KOMATSU MINING GERMANY GMBH, 40599 Düsseldorf (DE)

(21) Appl. No.: 15/124,227

(22) PCT Filed: Feb. 12, 2015
(86) PCT No.: PCT/DE2015/000082

§ 371 Date: Sep. 7, 2016

(30) Foreign Application Priority Data
Mar. 7, 2014 (DE) 10 2014 003 469.0

(51) Int. Cl. E06C 5/06; F15B 1/04; F15B 15/20; F15B 1/02

(52) U.S. Cl. CPC E06C 5/06; F15B 1/021; F15B 1/04; F15B 15/202

(57) ABSTRACT

An emergency descent system includes at least one descent means formed as a ladder which is articulated on at least one supporting unit on bearing means provided for this purpose, and the descent means is designed to be unfolded about this bearing means out of a rest position in which the descent means is disposed parallel to the support means and into a working position, wherein a push-out unit and a pivot unit operatively connected thereto by means of a catch are associated with the descent means and the pivot unit drives the push-out unit by the kinetic energy generated during the unfolding, wherein the push-out unit moves away from the supporting unit at a first acute angle, wherein in the operating position the push-out unit forms an acute angle with the supporting unit and the pivot unit is held at an obtuse angle relative to the push-out unit on a stop associated with the supporting unit.

The present invention relates to a self-rescue system including at least one descent means constructed as a ladder which is pivotally connected to at least one support unit that is assigned to a large machine on bearing means provided therefore and the descent means is configured to be foldable about these bearing means from a resting position into an operating position.

Self-rescue systems are required in many large machines to enable operating personnel for example to evacuate from the large machine via a conventional descent or ascent if needed via a particular route. Such self-rescue systems are intended to ensure a fastest possible evacuation in the event of an accident. Such systems not only have to meet high demands with regard to their operational reliability but also an increased functionality and health relevant comfort requirements.

From the state of the art rescue systems are known which are intended to enable a vertical descent of operating personnel by means of a throw ladder. Also known are sliding ladders or folding systems, which are intended to enable a descent when needed.

Even though these self-rescue systems have proven useful, they have the disadvantage that self-rescue from great heights poses considerable risks for a user, especially when the user is injured, because these self-rescue systems provide poor comfort and do not meet the safety requirements of the users.

It is therefore an object of the present invention to provide a self-rescue system for a large machine, which overcomes the above-mentioned disadvantages. In particular a controlled deployment of the self-rescue system from a resting position into an operation position is to be ensured.

This object is solved by the features in claim 1, in particular in that the descent means includes a push-out unit and a pivot unit operatively connected with the push-out unit via a catch and the pivot unit drives the push-out unit by the kinetic energy generated by the pivoting, wherein the push-out unit moves away from the support unit in a first acute angle and the pivot unit is held at a second obtuse angle relative to the push-out unit on a stop assigned to the support unit.

In an advantageous embodiment of the self-rescue system according to the invention it is provided that the outward movement of the push-out unit and the pivoting movement of the pivot unit is decelerated by a speed throttling. An additional speed throttling may be required when the large machine for example is not even but is tilted relative to the ground. This may result in greater initial speeds during release as a result of changed tilting moments during folding out of the pivot unit, which are not sufficiently counteracted by the counter weight of the push-out unit and may lead to injury to persons situated underneath the self-rescue system

In a further particularly advantageous embodiment of the self-rescue system according to the invention the support unit, the push-out unit and the pivot unit and also the speed throttling are connected to form an assembly unit. This makes it possible to pre-assemble the self-rescue system in a manner that is adapted to the large machine. The system can thus be dismounted from the large machine if needed and mounted on another large machine of the same type.

According to another advantageous embodiment of the present self-rescue system the support unit has an upper free end and a lower free end when installed. The push-out unit is hereby pivotally connected on the upper free end via the bearing means and at the lower free end to a lever plate which receives the bearing means, and is connected with the support unit via a bearing means assigned to the lever plate so that the push-out unit can be moved away from the support unit by the value of the distance between the bearing means and the bearing means.

In a further particularly advantageous embodiment, the push-out unit is connected with the support unit via a tension spring. As a result during the outward movement the push-out unit is always pushed against the catch (lever plate) of the pivot unit.

In a further embodiment of the self-rescue system according to the invention the speed throttling for decelerating the pivot movement of the pivot unit is configured as a hydraulic cylinder braking system with a compensation unit configured as a pressure accumulator.

In a further embodiment a compression spring is provided for pushing the pivot unit away from the support unit. The compression spring is connected with the support unit in the region of the upper free end and is supported on the pivot unit. In the resting position the compression spring is preloaded and in the operating position of the pivot unit substantially relaxed.

In a further particularly preferred embodiment a helical spring arranged in the pivot point of the push-out unit pushes the push-out unit is with its free lower end constantly against the catch (lever plate) of the pivot ladder unit during the outward movement.

In a further particular advantageous embodiment the speed of the pivot unit is reduced with a tension spring, which connects the push-out unit with the support unit. Via the catch (lever plate) the force is transmitted to the pivot ladder unit and as a result the speed of the pivot ladder unit is limited.

In a further advantageous embodiment the push-out unit is moved by the pivot ladder unit into the folded out position via a lever-/guide mechanism. Hereby the push-out unit is guided in a guide groove arranged on the lever plate by a bolt provided on its lower free end. The lever plate is connected with the pivot unit. The bolt of the push-out unit is guided in the guide groove. As a result when unfolding the pivot unit from the resting position into the operating position the push-out unit is pushed outwardly away from the support unit.

In a further embodiment of the self-rescue system according to the invention a compression spring pushes the push-out unit into the operating position in which it is spaced apart from the support unit. This compression spring also connects the push-out ladder unit with the support unit.

A further particularly advantageous embodiment is a torsion spring arranged in the rotation center of the push-out unit, which pushes the push-out unit into the operating position.

In a further particularly advantageous embodiment of the self-rescue system according to the invention two hydraulic cylinders, which are interconnected via hydraulic lines and have pressure accumulators as compensation unit, are assigned to the speed throttling. It is provided that the first hydraulic cylinder absorbs the kinetic energy of the pivot unit during unfolding and transmits the kinetic energy to the second hydraulic cylinder and that the push-out unit can be moved apart from the support unit with the inputted kinetic energy.

In a further advantageous embodiment of the self-rescue system according to the invention the push-out unit and the pivot unit can be driven via pressure accumulators that are connected with the hydraulic cylinders and which can be triggered by means of directional valves by manual actuation.

According to an advantageous embodiment, the hydraulic cylinders, and with this the drive for the push-out unit and the pivot unit, are connected via a hydraulic oil supply which can be triggered by means of directional valves by manual actuation and foot actuation and further hydraulic components (valves). Via hydraulic control components the hydraulic supply can move the push-out unit and the pivot unit back into the resting (starting) position again.

In a further particularly advantageous embodiment the push-out unit is driven by the pivot ladder unit via a pinion or pinions/toothed rack combination. The toothed rack slides on a guide rail of the support unit. On the outwardly oriented end of the toothed rack a guide is located which guides the push-out unit in the lever plate by means of a cam. The pinion gear drive is fixedly connected with the pivot ladder unit. During downward pivoting of the pivot ladder unit the pinion may drive the toothed rack directly or via a further gear (intermediate gear), which is rotatably supported on the support unit. The push-out unit is thus driven by the pivot unit via a pinion/toothed rack combination, wherein the toothed rack is arranged slidingly on a guide and the push-out unit is guided by means of a cam. The drive gear is fixedly connected with the pivot unit, coaxial to the bearing means and during downward pivoting of the pivot unit drives the toothed rack directly or via the intermediate gearwheel.

According to an advantageous embodiment the push-out unit of the self-rescue system can be provided with an unfoldable back protection. The back protection is pivotably supported on the push-out unit with bearing means and folds out when the push-out unit is pivoted, in that the back protection is kicked or is pulled along by a catch situated on the pivot unit. The weight of the back protection causes it to fall against stops provided on the push-out unit. The back protection is formed by arches, which are interconnected by rods, and of bearing means. In the starting position the pivotable back protection is pushed against the push-out unit by the pivot ladder unit.

The foldout movement of the pivot unit can also be limited or throttled with a valve arranged in the hydraulic circuit of the hydraulic cylinders. With this the pivot unit can generally be held at any angle relative to the push-out unit and the support unit. This can be advantageous in particular when the large machine is tilted relative to the ground.

In a particularly advantageous embodiment of the self-rescue system according to the invention it is provided that the pivot unit can be fixed in the resting position at the upper free end of the support unit with a release mechanism. The release mechanism is advantageously configured as foot-operable mechanism, which can be triggered after prior pulling of a safety bolt. The release mechanism can be configured spring loaded so that the pivot unit is automatically pivoted away or pushed away from the support unit by the impulse induced by the preloaded spring.

In the following the invention is explained in more detail by way of an exemplary embodiment with reference to the included drawings. It is shown in:

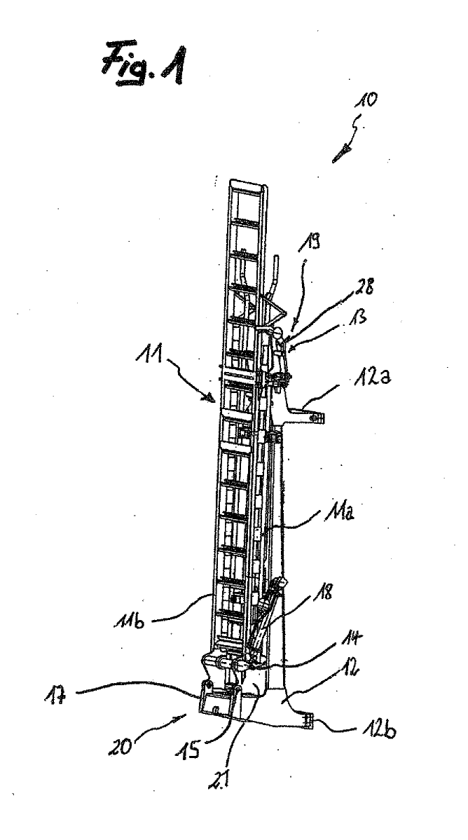

FIG. 1 an isometric representation of a first embodiment of the self-rescue system according to the invention in the resting position in which the push-out unit and the pivot unit rest against each other and are oriented parallel to the carrier unit;

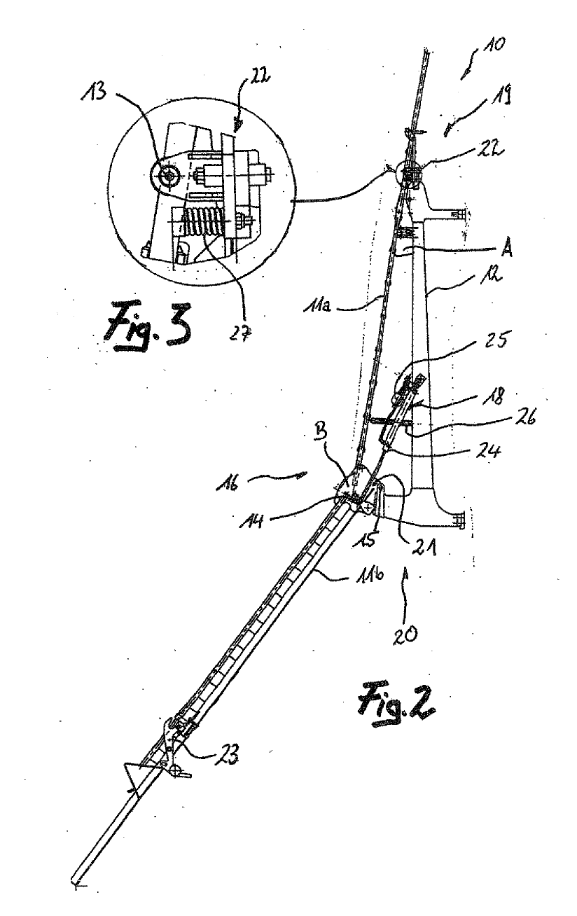

FIG. 2 the isometric representation of the self-rescue system according to the invention in the operating position, wherein in the unfolded state the two-part ladder system has a walk-friendly tilting angle relative to the carrier means;

FIG. 3 an enlarged representation in side view of the release mechanism as shown in FIG. 2;

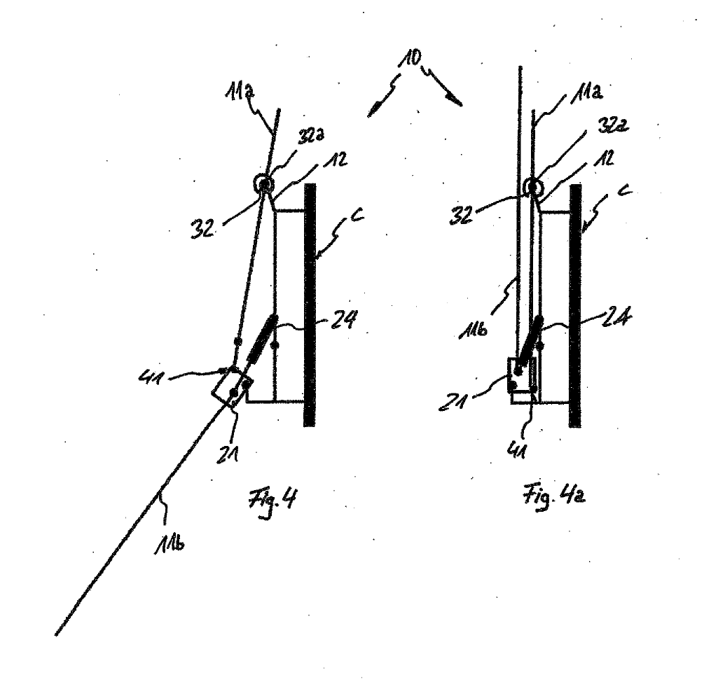

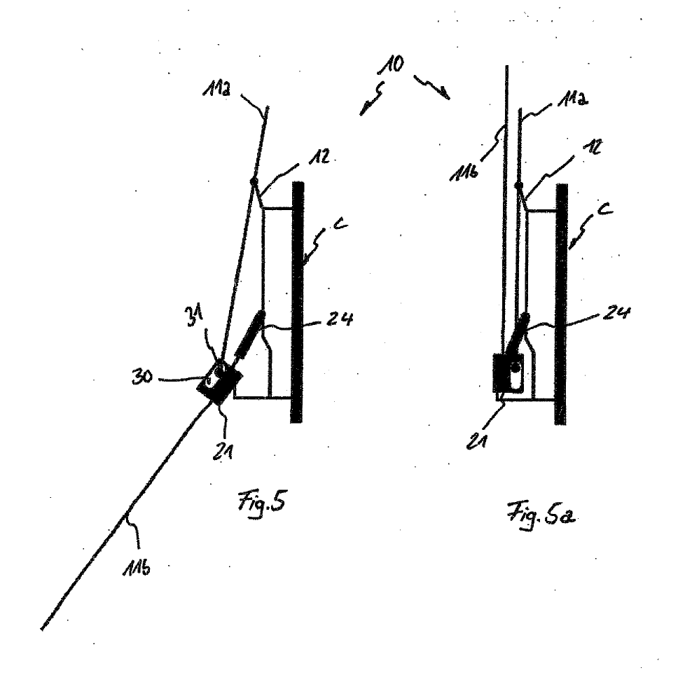

FIG. 4 the schematic representation of the self-rescue system according to the invention in the operating position as in FIG. 12, wherein a torsion spring is assigned to the push-out unit at the point at which the push-out unit is pivotally connected;

FIG. 4a the self-rescue system according to the invention according to FIG. 4 in the resting position;

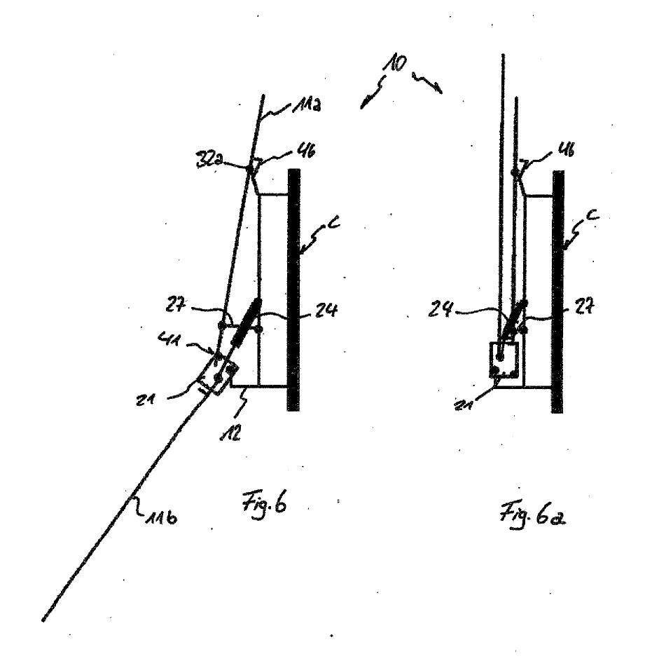

FIG. 5 the schematic representation of a further embodiment of the self-rescue system according to the invention, wherein the push-out unit is connected with the pivot unit via a groove and bolt system via a guide groove;

FIG. 5a the self-rescue system according to FIG. 5 in the resting position;

FIG. 6 the schematic representation of the self-rescue system of FIG. 1, wherein a mechanical stop is provided in the region of the upper free end of the support unit;

FIG. 6a the self-rescue system according to FIG. 6 in the resting position;

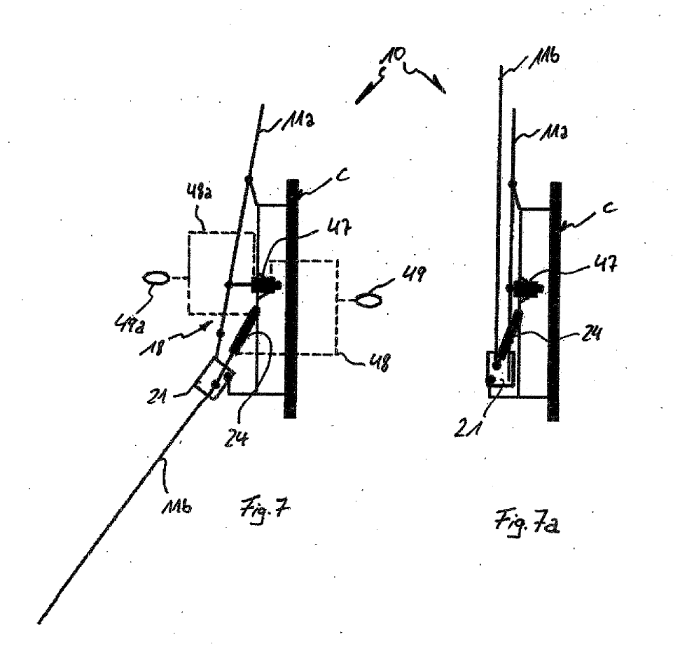

FIG. 7 the schematic representation of a further embodiment of the self-rescue system according to the invention with a second hydraulic cylinder unit and assigned pressure accumulators in order to move the push-out unit and the pivot unit from the resting position into the operating position and vice versa in a controlled manner;

FIG. 7a the self-rescue system according to FIG. 7 in the resting position;

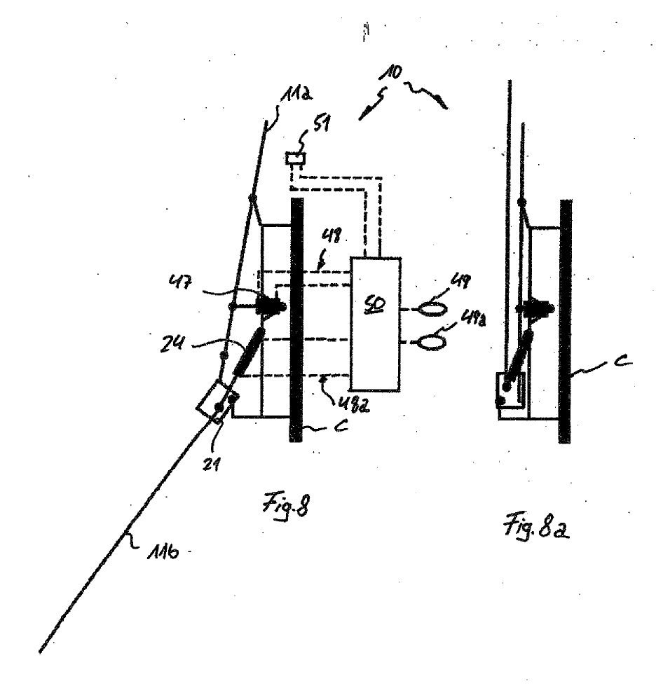

FIG. 8 the schematic representation of a further embodiment of the self-rescue system according to the invention with two hydraulic cylinders, wherein the hydraulic cylinders are connected with each other via a hydraulic control with preloaded pressure accumulators and the self-rescue system can be moved from the resting position in to the shown operating position via a hydraulic directional valve;

FIG. 8a the self-rescue system according to FIG. 8 in the resting position;

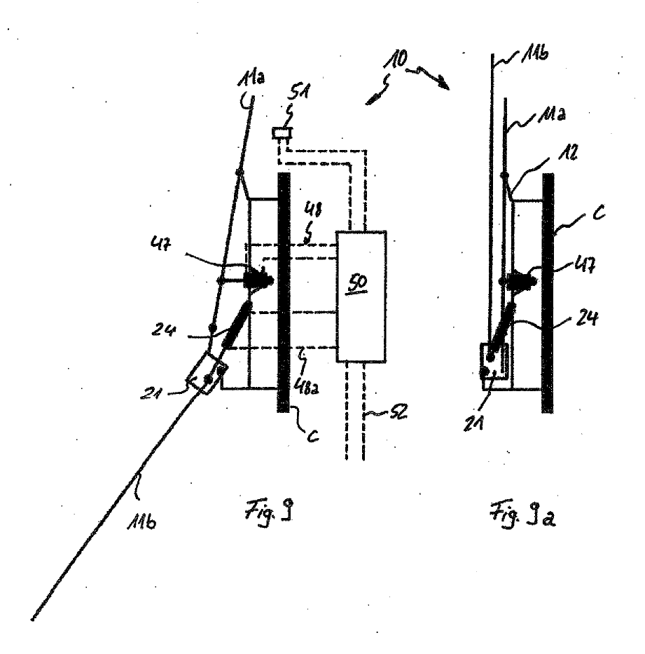

FIG. 9 the schematic representation of a further embodiment of the self-rescue system according to the invention with two hydraulic cylinders according to FIG. 8, wherein the hydraulic power supply is supplied to the hydraulic control by an external aggregate (large machine);

FIG. 9a the self-rescue system according to FIG. 9 in the resting position;

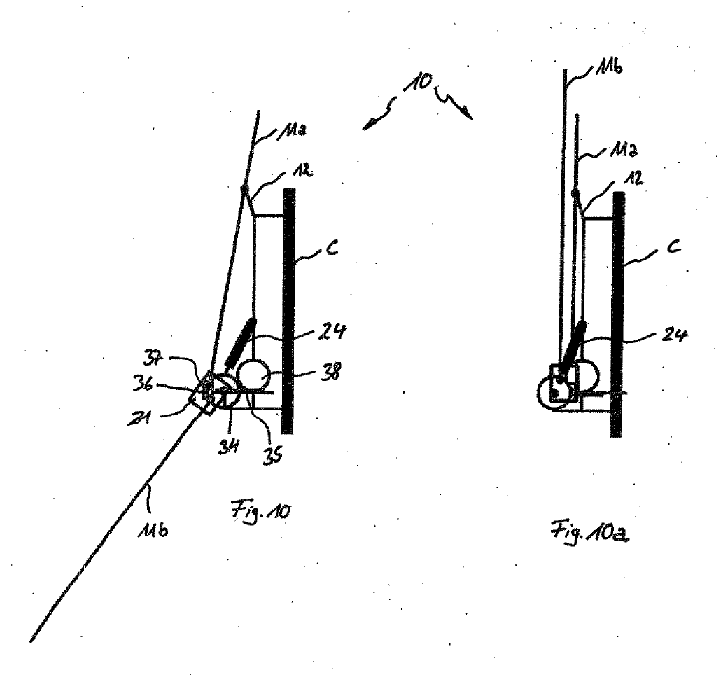

FIG. 10 the schematic representation of a further embodiment of the self-rescue system according to the invention with only one hydraulic cylinder for limiting the pivot speed, wherein the pivot unit is configured for pivoting about the axis of a gearwheel fixedly connected with the pivot unit and the push-out unit is operatively connected with the pivot unit via an intermediate rotatably supported in the support unit and a gear rod via the fixed gearwheel;

FIG. 10a the self-rescue system according to FIG. 10 in the resting position;

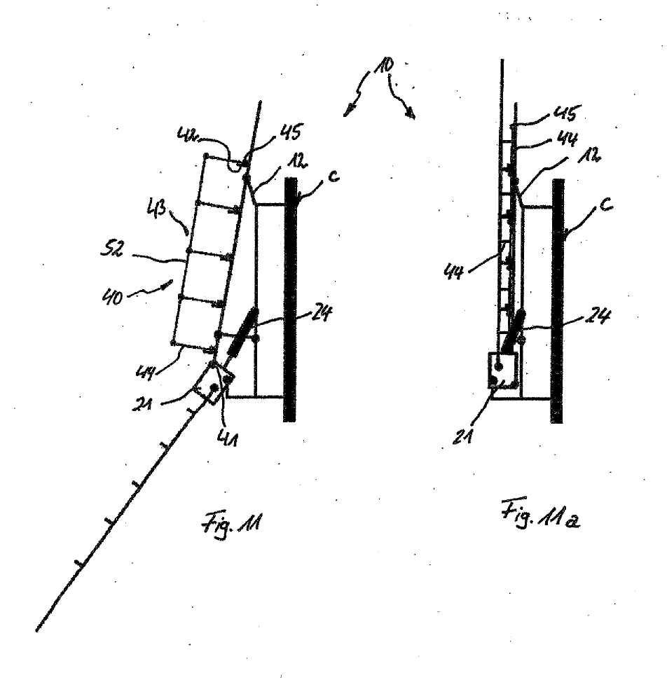

FIG. 11 the schematic representation of a further embodiment of the self-rescue system according to the invention according to one or more of the FIGS. 1 to 10 above wherein a foldable and unfoldable back protection is assigned to the push-out unit, which back protection is pivotally connected on the push-out unit via bearing means.

FIG. 11a the self-rescue system according to FIG. 11 in the resting position.

In all Figures the same components are always provided with the same reference numerals. As shown in FIG. 1 the self-rescue system 10 is substantially formed by a two-part descent means 11, which in the resting position—i.e., in the folded state—forms a compact unit. The descent means 11 is divided into a push-out unit 11a and a pivot unit 11b, which in the resting position are configured to rest against each another in parallel relationship with each other. The two-part descent means 11 is held by a support unit 12 connected with the descent means. The support unit 12 is connected on a side surface C to a large machine (not shown) for example by screwing.

The support unit 12 in turn is releasably connected with a not shown large machine with connection means 12a, 12b. The support unit 12 and the descent means 11 are configured in the resting position so as to only protrude over the footprint of the large machine (for example an industrial hydraulic back hoe) to an extent that enables avoiding a collision with another vehicle (for example a large excavation kipper). The unit of descent means 11 and support unit 12 is further configured so as to not hinder the pivot radius of the superstructure of a large machine.

The push-out unit 11a is rotatably connected with the support unit 12 on the upper free end 19 of the support unit via bearing means 13. The pivot unit 11b is rotatably connected with the support unit 12 at the lower free end 20 of he support unit via a bearing means 15. A lever plate 21 is provided which is fixedly (rigidly) connected with the pivot unit 11b. The lever plate 21 in turn is rotatably connected with the support unit 12 at its lower free end 20 via a bearing means 15.

Generally the push-out unit (11a) and the pivot unit (lib) can be formed as ladder elements with rungs or as stair elements with stepping and/or sitting steps or a combination of ladder element and stair element. For example the push-out unit (11a) can be configured as a ladder element and the pivot unit (11b) as a stair element or vice versa.

FIG. 2 shows the self-rescue system 10 according to the invention in the operating position. Hereby the push-out unit 11a and the pivot unit 11b of the descent means 11 are spaced apart from the carrier means 12 and form over the entire length of the constructive height a slant 16. The slant 16 is hereby angled relative to the support unit 12 so that the bodily exertion during descent or during walking is within the range of the statistical average fitness of a user. Correspondingly the angle is selected as large as possible in order to from a walk friendly slant in the pivoted state.

The pivot ladder system can be installed in a large hydraulic backhoe. The assembly made of the descent means 11 and the carrier means 12 is screwed to various locations of the upper structure of the vehicle. As described above the assembly serves for being able to quickly and safely escape from the machine in the event of an emergency (fire on the large machine or other hazardous situations). Hereby the undercarriage (for example a crawler chassis) can be oriented rotated diagonally relative to the superstructure (both not shown).

The self-rescue system 10 is triggered via a release mechanism 22, which is shown again enlarged in FIG. 3. Hereby the pivot unit 11b is released with the holding claw 23 assigned to the pivot unit from the release mechanism 22, which is assigned to the upper free end 19 of the support unit 12. In this embodiment it is provided that the release mechanism 22 is configured to be operated by foot, but also a hand operated release mechanism is possible.

In order to prevent an unintended release, a safety bolt 28 is provided which fixes the holding claw 23 relative to the support unit 12. After pulling the safety bolt 28 an impulse introduced into the holding claw 23 releases the holding claw from the release mechanism 22 and the pivot unit 11b then automatically pivots downwards due to gravity acting on the pivot unit into the operating position.

The pivot unit 11b is hereby on one side fixedly connected with the lever plate 21 and on the other side connected on the lower free end 20 of the support unit 12 with the bearing means 15 assigned to the lever plate for rotation. Catch 41 and bearing means 15 are spaced apart from each other in the lever plate 21, as result of which the lever plate functions as lever.

Hereby the downwardly pivoting pivot unit 11b drives the push-out unit 11a by means of the lever mechanism and moves the push-out unit away from support unit 12 into a position that is slanted relative to the support unit 12 with a first angle A. The pivot process is finished when the pivot unit 11b has reached a mechanical stop 17 arranged on the support unit 12. Hereby the pivot unit 11b forms a flattest possible angle B together with the push-out unit 11a. It is hereby provided that the pivot unit 1b in the pivoted state does not rest on the ground (not shown) but is rather suspended freely above the ground. Instead of the mechanical stop 17 or in addition to the mechanical stop 17 also a hydraulic holding device can be provided which holds the pivot unit in a predetermined manner above the ground.

In this embodiment it is provided that the pivot speed is controlled for safety reasons via a speed throttling device 18.

In this embodiment the speed throttling device 18 is a hydraulic cylinder unit 24 with a pressure accumulator 25 connected to the hydraulic cylinder unit 24 and a throttle (not shown).

Because the lever mechanism guides the push-out unit 11a in only one direction the push-out unit is free in the opposite direction. When descending, the user supports his/herself and pulls the push-out unit 11a toward himself and away from the support unit 12. In order for the user to not pull the push-out unit 11a toward himself/herself and thus inadvertently push it to an unwanted degree away from the support unit 12, a tension spring 26 is provided which connects the push-out unit 11a with the support unit 12 and thus prevents an uncontrolled moving away by a user from the support unit 12.

The downward pivoting pivot unit 11b exerts an amount of energy, which is sufficient to push out the push-out unit 11a and also to overcome the force of the tension spring 26 and the speed throttling 18. Hereby the weights of the individual components and the tensile and compression stresses of the above mentioned throttling means are adjusted to each other.

Push-out unit 11a. In this embodiment a torsion spring 32 is assigned on the upper free end 19 to the support unit 12 on a pivot point 32a. The torsion spring 32a is thus connected with the push-out unit 11a so that the push-out unit is able to rotate about the pivot point 32. During pivoting out or moving apart the push-out unit 11a is force fittingly pushed with its lower free end 33 against a catch 41, which is arranged on the lever plate 21. This prevents the push-out unit 21 from unintentionally lifting or jumping off. The hydraulic cylinder unit 24 is on one side connected with the support unit 12 and on the other side with the pivot unit 11b via the lever plate 21.

FIGS. 5 and 5a show a further embodiment of the bearing or guided connection between the push-out unit 11a and the pivot unit 11b in the operating position or resting position. Hereby a guide groove 30 is provided in the lever plate 21. In the guide groove 30 the push-out unit 11a is guided on the bolt 31 that is assigned to its lower free end 33. During pivoting of the pivot unit 11b the speed of the foldout movement is controlled via the hydraulic cylinder unit 24. The bolt 31 is guided during the unfolding out or folding in the guide groove 30.

FIG. 6 and FIG. 6a differ form the embodiment according to FIG. 1 in that a mechanical stop 46 is arranged in the support unit 12 above the pivot point 32a and instead of a tension spring a compression spring 27 connects the push-out unit 11a with the support unit 12. The mechanical stop 46 limits the deflection of the compression spring 27 and holds the push-out unit 11a in the operating position under spring tension. In order to prevent sagging of the push-out unit ha when a user walks on it, the push-out unit is connected with the catch 41 on the lower free end 33.

FIG. 7 and FIG. 7a show a further embodiment of the emergency descending system 10 on one hand in the operating position and on the other hand in the resting position. Hereby two hydraulic cylinder units 24, 47 that are interconnected via a hydraulic circuit 48, 48a (shown in dashed lines) with pressure accumulator 49, 49a as compensation means are assigned to the speed throttling 18, wherein the first hydraulic cylinder unit 24 absorbs the kinetic energy of the pivot unit 11b during the pivoting out and transmits the kinetic energy to the second hydraulic cylinder unit 47 via the hydraulic circuit 48, 48a and with the introduced kinetic energy moves the push-out unit 11a apart from the support unit 12.

FIG. 8 and FIG. 8a show a further embodiment of the emergence descent system 10 on one hand in the operating position and on the other hand in the resting position. Hereby the push-out unit 11a and the pivot unit 11b are driven via the preloaded pressure accumulators 49, 49a that are connected with the hydraulic cylinder units 24, 47 by the hydraulic circuit 48 48a via at least one hydraulic directional valve 51. The hydraulic directional valve 51 can be triggered by hand or foot and thereby the emergency descent system 10 can be brought from the resting position into the operating position. Hereby the hydraulic supply is configured so that via a hydraulic control component 50, which is connected with the pressure accumulators 49, 49a, the push-out unit 11a and the pivot unit 11b can also be displaced/moved back into the resting position again.

FIG. 9 and FIG. 9a show a further embodiment of the emergency descent system 10 according to the invention, on one hand in the operating position and on the other hand in the resting position, wherein the supply of the hydraulic cylinder units 24, 47 and with the drive of the push-out unit 11a and the pivot unit 11b occurs via an external hydraulic supply 52, which can be triggered by hand or by foot by means of at least one hydraulic directional valve 51. The hydraulic cylinder units 24, 47 are controlled via the hydraulic circuit 48, 48a connected with the control component 50.

FIG. 10 and FIG. 10a show a further embodiment of the emergency descent system 10 on one hand in the operating position and on the other hand in the resting position, wherein the drive of the push-out unit 11a is accomplished by the pivot unit 11b via a drive gearwheel 34 and an intermediate gearwheel/gear rod combination, wherein the toothed rack 35 is arranged slidingly on a guide mechanism 36 (guide) and guides the push-out unit 11a by means of a cam 37. The drive gearwheel 34 is in this embodiment fixedly connected with the pivot unit 11b (coaxial to the bearing means) and drives during downward pivoting of the pivot unit 11b the toothed rack 35 via the intermediate gearwheel 38, which toothed rack drives the outward movement of the push-out unit 11a via the cam 37. The hydraulic cylinder unit 24 is connected with the lever plate 21 and can have a pressure accumulator (volume compensation accumulator) and a throttle in order to be able to limit the pivot speed of the pivot unit 11b.

FIG. 11 and FIG. 11a show a further embodiment of the emergency descent system 10, on one hand in the operating position and on the other hand in the resting position with an additional means arranged thereon. The additional means is not necessarily limited to this embodiment but can rather be brought in operative connection with all embodiments described in the description. The additional means is an unfoldable back protection 40 which together with the push-out unit 11a can be unfolded or folded. During the unfolding of the push-out unit 11a the back protection 40 is pulled along by a catch 53 of the pivot unit 11b and unfolded. During the pivoting out of the push-out unit 11a the back protection 40 is moved as a result of the gravity acting on it against stops 42 provided on the push-out unit 11a. In the resting position the unfoldable back protection 40 is pushed against the push-out unit 11a by the pivot unit (11b). The back protection 40 is formed by arches 43, which are made of correspondingly arched rods or bands 44 which are aligned with each other in longitudinal direction of the push-out unit 11b. The arches 43 of the back protection 40 are supported on the push-out unit for rotation via bearing means 45. The individual rods or bands 44 of the arches 43 are connected with each other via an intermediate guide rod 52 which is arranged on the apex of the curvature of the arches. The arches 43 together with the push-out unit 1a thus form a walkable tunnel-like protective tube.

List of reference signs

| | |
|---|---|
| 10 | emergency descent system |
| 11 | descent means |
| 11a | push-out unit |
| 11b | pivot unit |
| 12 | support unit |
| 13 | bearing means |
| 15 | bearing means |
| 16 | slant |
| 17 | stop |
| 18 | throttle |
| 19 | Upper free end |
| 20 | Lower free end |
| 21 | lever plate |
| 22 | release mechanism |
| 23 | holding claw |
| 24 | hydraulic cylinder unit |
| 25 | pressure accumulator |
| 26 | tension spring |
| 27 | compression spring |
| 28 | safety bolt |
| 30 | guide groove |
| 31 | bolt |
| 32 | torsion spring |
| 32a | rotation point |
| | angle A |
| | angle B |
| | side surface |
| 33 | lower free end push-out unit |
| 34 | drive gearwheel |
| 35 | gear rod |
| 36 | guide mechanism |
| 37 | cam |
| 38 | intermediate gearwheel |
| 40 | back protection |
| 41 | catch |
| 42 | stops |
| 43 | arches |
| 44 | rods |
| 45 | bearing means |
| 46 | mechanical stop |
| 47 | hydraulic cylinder unit |
| 48 | hydraulic circuit |
| 48a | hydraulic circuit |
| 49 | pressure accumulator |
| 49a | pressure accumulator |
| 50 | control component |
| 51 | hydraulic directional valve |
| 52 | intermediate guide rod |
| 53 | catch |

1.-22. (canceled)

23. An emergency descent system, comprising:
at least one support unit having a stop and being assigned to a large machine; and
at least one descent means configured as a ladder and comprising a push-out unit and a pivot unit, said pivot unit being operatively connected with the push-out unit via a catch, said at least one descent means being pivotally connected to the at least one support unit via bearing means for pivoting about the bearing means from a resting position into an operating position,
wherein during the pivoting into the operating position the pivot unit generates kinetic energy and with the kinetic energy drives the push-out unit to undergo an outward movement away from the support unit, and wherein in the operating position the push-out unit forms an acute angle with the support unit and the pivot unit is held on the stop of the support unit at an obtuse angle relative to the push-out unit.

24. The emergency descent system of claim 23, further comprising a tension spring for braking the outward movement of the push-out unit and a speed throttling for braking the pivoting of the pivot unit.

25. The emergency descent system of claim 23, wherein the support unit, the push-out unit and the pivot unit and the speed throttling are connected with each other so as to form a single constructive unit.

26. The emergency descent system of claim 23, wherein in an installed position of the support unit, the support unit has an upper free end and a lower free end and the push-out unit is connected with the support unit at the upper free end via a first one of the bearing means and is connected to the support unit via the catch, which is received by the lever plate which is connected with the lower free end of the support unit via another one of the bearing means, wherein the push-out unit is connected with the support unit via the catch so that the push-out unit is movable apart from the support unit by a distance value of an effective distance between the catch and the another bearing means.

27. The emergency descent system of claim 26, wherein the push-out unit is connected with the support unit via a tension spring which causes the push-out unit during the outward movement to be always pushed against the catch of the lever plate which is connected with the pivot unit.

28. The emergency descent system of claim 27, wherein a speed of the pivoting of the pivot unit is reducible via the tension spring, wherein a force occurring during the pivoting of the pivot unit is transmitted to the pivot unit via the catch and the lever plate thereby limiting the speed of the pivoting of the pivot unit.

29. The emergency descent system of claim 26, further comprising a lever/guide mechanism by which the push-out unit can be brought from the resting position into the operating position.

30. The emergency descent system of claim 26, further comprising a torsion spring arranged in a rotation point of the push-out unit, said torsion spring constantly pushing a free end of the push-out unit against the catch of the lever plate during the outward movement.

31. The emergency descent system of claim 30, wherein the torsion spring forms the one of the bearing means and the push-out unit is rotatably arranged in the rotation point of the bearing means so as to be pushable via the torsion spring from the resting position into the operating position.

32. The emergency descent system of claim 26, further comprising a compression spring connecting the push-out unit with the support unit, said compression spring pushing the push-out unit from the resting position into the operating position.

33. The emergency descent system of claim 32, further comprising another compression spring connected with the support unit in a region of the upper free end of the support unit and being supported against the pivot unit, said other compression spring being configured for moving the pivot unit apart from the support unit, said other compression spring being preloaded in the resting position and relaxed in the operating position.

34. The emergency descent system of claim 26, wherein the speed throttling is constructed as a hydraulic cylinder brake system comprising a compensation unit which is configured as a pressure accumulator.

35. The emergency descent system of claim 34, wherein the speed throttling comprises two hydraulic cylinder units each having one said compensation unit, said two hydraulic cylinder units being interconnected via a hydraulic circuit, wherein one of the hydraulic cylinder units takes up the kinetic energy of the pivot unit during the pivoting of the pivot unit and transmits the kinetic energy to the other one of the hydraulic cylinder units via the hydraulic circuit and with the introduced kinetic energy moves the push-out unit away from the support unit.

36. The emergency descent system of claim 35, wherein the push-out unit and the pivot unit are driven via the pressure accumulators, which are connected with the hydraulic cylinder units via the hydraulic circuit, said pressure accumulators being be activatable by means of hydraulic directional valves by hand or by foot actuation, to thereby move the emergency descent system from the resting potion into the operating position, wherein a hydraulic supply of the hydraulic cylinders is configured so that the push-out unit and the pivot unit can be moved from the operating position into the resting position via a control component connected with the pressure accumulators.

37. The emergency descent system of claim 36, wherein the supply of the hydraulic cylinders and with this the drive for the push-out unit and the pivot unit is implemented with an external hydraulic oil supply which can be triggered by means of directional hydraulic valves by manual actuation.

38. The emergency descent system of claim 37, further comprising a throttle arranged in the hydraulic circuit of the hydraulic cylinders and configured to limit the pivoting of the pivot unit.

39. The emergency descent system of claim 26, wherein the pivot unit drives the push-out unit via a pinion, an intermediate gearwheel and a toothed rack, said toothed rack being arranged slidingly on a guide and guides the push-out unit by means of a cam.

40. The emergency descent system of claim 39, wherein the pinion is fixedly connected with the pivot unit in coaxial relationship with the another one of the bearing means and wherein during a downward pivoting of the pivot unit the pinion directly drives the toothed rack.

41. The emergency descent system of claim 39, wherein the pinion is fixedly connected with the pivot unit in coaxial relationship with the another one of the bearing means and during a downward pivoting of the pivot unit the pinion drives the toothed rack via a further intermediate gearwheel which is rotatably supported on the support unit.

42. The emergency descent system of claim 23, further comprising a release mechanism, configured for fixing the pivot unit in the resting position at the upper free end of the support unit.

43. The emergency descent system of claim 23, further comprising an unfoldable back protection which is rotatably supported on the push-out unit with further bearing means.

44. The emergency descent system of claim 43, wherein during the outward movement of the push-out unit the back protection is pulled along by another catch on the pivot unit and is folded out and due to gravity falls against further stops provided on the push-out unit, wherein in the resting position the unfoldable back protection is pushed against the push-out unit.
